(19) United States
(12) Patent Application Publication
(10) Pub. No.: US 2026/0264004 A1
(43) Pub. Date: Sep. 10, 2026

(54) DEHUMIDIFIER

(71) Applicant: LG ELECTRONICS INC., Seoul (KR)

(72) Inventors: Sangjin Park, Seoul (KR); JinWoo Been, Seoul (KR); Hyunwoo Lee, Seoul (KR)

(73) Assignee: LG ELECTRONICS INC., Seoul (KR)

(21) Appl. No.: 19/236,189

(22) Filed: Jun. 12, 2025

(30) Foreign Application Priority Data
Mar. 10, 2025 (KR) 10-2025-0030463

(51) Int. Cl. B01D 53/26

(52) U.S. Cl. CPC B01D 53/265; B01D 2257/80

(57) ABSTRACT

Proposed is a dehumidifier in which a connector mounting part for mounting a connector of a wire is formed on at least one portion of a fan assembly. Therefore, the connector can be mounted at a predetermined location.

### CROSS REFERENCE TO RELATED APPLICATION

The present application claims priority to Korean Patent Application No. 10-2025-0030463, filed Mar. 10, 2025, the entire contents of which are incorporated herein for all purposes by this reference.

### BACKGROUND OF THE INVENTION

### Field of the Invention

The present disclosure relates generally to a new type of dehumidifier having a structure for organizing connectors of respective signal lines provided to the dehumidifier.

### Description of the Related Art

Generally, a dehumidifier is a device or appliance that removes moisture from air in an indoor space.

Such a dehumidifier is configured to remove moisture from air in a space by drawing in the air and passing the air through a heat exchanger, thereby removing the moisture from the air through heat exchange with the heat exchanger.

The heat exchanger includes a condenser that condenses refrigerant and an evaporator that evaporates refrigerant. That is, while air passes through the evaporator, the air exchanges heat with refrigerant, thereby removing moisture of the air, and while the air passes through the condenser, the air absorbs the heat released from the refrigerant and is supplied indoors in a dried state, thereby lowering the humidity of the indoor space.

In addition, the dehumidifier has a water tank and is configured to collect and store moisture separated from air while the air passes through the evaporator, and then discharge the moisture when necessary.

Regarding the conventional dehumidifier, various patents are provided, such as Korean Patent No. 10-2506410, Korean Patent Application Publication No. 10-2025-0006644, Korean Patent Application Publication No. 10-2025-0006645, Korean Patent Application Publication No. 10-2025-0006646, and Korean Patent Application Publication No. 10-2025-0006647.

Meanwhile, a dehumidifier is provided with various sensors. For example, various sensors may be provided, such as a sensor that senses various types of information related to a heat exchanger or a sensor that detects the water level of a water tank or whether water is being extracted.

Accordingly, a number of wires (power lines, signal lines, etc.) are provided inside a conventional dehumidifier, and a number of connectors are provided for connecting these wires to a main board.

In the past, the above-mentioned wires had to be provided within a casing while avoiding interference with coupling between various parts without being organized separately. That is, there was an inconvenience in that wires or connectors were placed at each coupling portion during the conventional process of coupling various parts or covering the casing, making the work difficult.

In particular, there were cases where a worker forcibly coupled parts without noticing that wires were caught between each coupling portion, which resulted in malfunctions due to damage to the wires or separation between connectors.

In addition, because multiple wires and connectors are placed in different locations for each product depending on the preference of a worker, there was a problem in which it was difficult to find wires or connectors of each part during later inspection or maintenance of each connector.

### Documents of Related Art

(Patent Document 1) Korean Patent No.10-2506410

(Patent Document 2) Korean Patent Application Publication No. 10-2025-0006644

(Patent Document 3) Korean Patent Application Publication No. 10-2025-0006645

(Patent Document 4) Korean Patent Application Publication No. 10-2025-0006646

(Patent Document 5) Korean Patent Application Publication No. 10-2025-0006647

### SUMMARY OF THE INVENTION

Accordingly, the present disclosure has been made keeping in mind the above problems occurring in the related art, and the present disclosure is intended to enable various types of wires provided inside a casing to be supplied in an organized state.

The present disclosure is intended to enable a worker to accurately and quickly recognize the locations of various types of wires.

The present disclosure is intended to enable easy and accurate verification of connections between various types of wires.

The present disclosure is intended to enable connectors to which various types of wires are connected to be maintained in a stably installed state.

In order to achieve the objectives of the present disclosure, according to a dehumidifier of the present disclosure, a connector mounting part for mounting a connector of a wire may be formed on at least one portion of a fan assembly. Accordingly, the connector may be mounted at a predetermined location.

According to the dehumidifier of the present disclosure, the connector mounting part for mounting the connector of a wire may be formed on one portion of the fan assembly.

According to the dehumidifier of the present disclosure, the connector mounting part may include a plurality of connector mounting parts, and a plurality of different connectors may be mounted in the plurality of connector mounting parts, respectively.

According to the dehumidifier of the present disclosure, connectors of wires connected to the same device or apparatus may be formed to be collectively mounted in a connector mounting part. Accordingly, wires connected to the same type of device may be disposed together at a specific location.

According to the dehumidifier of the present disclosure, the connector mounting part may be provided on at least one of a fan housing and a shroud which constitute the fan assembly.

According to the dehumidifier of the present disclosure, the connector mounting part may include a first connector mounting part formed on an outer surface of the fan housing. The first connector mounting part may be formed integrally with the fan housing.

According to the dehumidifier of the present disclosure, the first connector mounting part may be formed at the edge portion of the fan housing for space utilization.

According to the dehumidifier of the present disclosure, the connector mounting par may include a second connector mounting part formed on an outer surface of the shroud. The second connector mounting part may be formed integrally with the shroud.

According to the dehumidifier of the present disclosure, the first connector mounting part and the second connector mounting part may be positioned to be adjacent to each other. Accordingly, work on connection portions between wires may be done collectively in one place.

According to the dehumidifier of the present disclosure, connectors of a plurality of wires connected to a sensor of a dehumidifying part may be collectively mounted on one of the first connector mounting part and the second connector mounting part. Accordingly, when performing maintenance on the sensor of the dehumidifying part, only the connectors mounted on the corresponding connector mounting part may be required to be checked.

According to the dehumidifier of the present disclosure, connectors of a plurality of wires connected to a device, apparatus, or component other than the dehumidifying part may be collectively mounted on the other one of the first connector mounting part and the second connector mounting part. Accordingly, when performing maintenance on a sensor of a water tank, only a connector mounted on the corresponding connector mounting part may be required to be checked.

According to the dehumidifier of the present disclosure, the two connector mounting parts may be formed so that the connectors are mounted to be directed in different directions. Accordingly, a worker may easily distinguish each type of connector connected to each of the connector mounting parts.

According to the dehumidifier of the present disclosure, the first connector mounting part may be formed so that the connector is mounted in a width direction of the fan housing. Accordingly, the connector may be mounted from the front of the fan housing, making connector mounting easy.

According to the dehumidifier of the present disclosure, the connector mounting part may be formed to have a flat bottom portion. Accordingly, each connector may be mounted horizontally even on a curved portion as in the edge portion of the fan housing.

According to the dehumidifier of the present disclosure, the connector mounting part may include at least two grip guides that grip the side surfaces of the connector. Accordingly, the connector may be stably installed without any left-right shaking.

According to the dehumidifier of the present disclosure, two grip guides of the grip guides may form one pair and may be formed to grip the opposite side surfaces of the connector. Accordingly, the connector may be stably installed without any left-right shaking.

According to the dehumidifier of the present disclosure, the grip guides may include a plurality of pairs of grip guides. Accordingly, a plurality of connectors may be collectively mounted in one connector mounting part.

According to the dehumidifier of the present disclosure, the plurality of pairs of grip guides may be arranged to be adjacent to each other in a horizontal direction. Accordingly, the plurality of connectors may be mounted horizontally side by side.

According to the dehumidifier of the present disclosure, the plurality of pairs of grip guides may be arranged in a plurality of vertical layers.

According to the dehumidifier of the present disclosure, the grip guide may have a structure formed to prevent the connector from being pushed in a coupling direction when a counterpart connector is coupled to the connector.

According to the dehumidifier of the present disclosure, each of the grip guides may include a structure configured to ensure that the connector is mounted to the connector mounting part by only a predetermined depth, without being excessively inserted.

According to the dehumidifier of the present disclosure, the limiting protrusion may be positioned to limit the connector from being pushed in the direction in which the two connectors are coupled.

According to the dehumidifier of the present disclosure, the grip guide may be formed to grip a portion of an upper surface of the connector.

As described above, in the dehumidifier of the present disclosure, the connector mounting part into which the connector of a wire is mounted may be provided within the casing, thereby allowing each wire to be organized without being tangled.

In the dehumidifier of the present disclosure, by providing the connector mounting part, a connector provided on the end of each wire may be mounted in a predetermined position. Accordingly, a worker may easily locate each wire.

In the dehumidifier of the present disclosure, with the provision of the connector mounting part, connectors may be categorized and positioned by type or device, thereby making maintenance by a worker easier and quicker.

In the dehumidifier of the present disclosure, the limiting protrusion may be provided on the connector mounting part, thereby preventing inaccurate coupling between a connector and a counterpart connector due to the connector pushed during coupling between the connectors.

In the dehumidifier of the present disclosure, the connector mounting part may be provided at the edge portion of the upper surface of the fan housing or the shroud which is provided as an empty space, thereby making the installation of the connector easier and space utilization possible.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view of a dehumidifier according to an embodiment of the present disclosure;

FIG. 2 is an exploded perspective view of the dehumidifier according to the embodiment of the present disclosure;

FIG. 3 is a perspective view of the dehumidifier viewed in an opposite direction to the direction of FIG. 1;

FIG. 4 is an exploded perspective view of the dehumidifier viewed in the opposite direction to the direction of FIG. 1;

FIG. 5 is a plan view of the dehumidifier according to the embodiment of the present disclosure;

FIG. 6 is a cross-sectional view taken along line A-A of FIG. 5 of the dehumidifier according to the embodiment of the present disclosure;

FIG. 7 is a cross-sectional view taken along line B-B of FIG. 5 of the dehumidifier according to the embodiment of the present disclosure;

FIG. 8 is a perspective view illustrating a state in which a connector mounting part is formed on a fan assembly of the dehumidifier according to the embodiment of the present disclosure;

FIG. 9 is an enlarged view of portion “A” of FIG. 8;

FIG. 10 is a perspective view illustrating a state in which connectors are installed in the connector mounting part of the dehumidifier according to the embodiment of the present disclosure;

FIG. 11 is an enlarged view of portion “B” of FIG. 10;

FIG. 12 is a side view of the fan assembly illustrating a state in which connectors are installed in the connector mounting part of the dehumidifier according to the embodiment of the present disclosure;

FIG. 13 is an enlarged view of portion “C” of FIG. 12;

FIG. 14 is a plan view of the fan assembly illustrating a state in which connectors are installed in the connector mounting part of the dehumidifier according to the embodiment of the present disclosure; and

FIG. 15 is an enlarged view of portion "D" of FIG. 14.

### DETAILED DESCRIPTION OF THE INVENTION

Embodiments of the present disclosure are described in detail with reference to exemplary drawings. When adding reference numerals to components in each drawing, it should be noted that identical components are given the same reference numerals as much as possible even if they are shown in different drawings.

In addition, when describing the embodiments of the present disclosure, if a detailed description of the relevant known configuration or function is judged to hinder understanding of the embodiments of the present disclosure, detailed descriptions thereof will be omitted.

In addition, in describing the components of the embodiments of the present disclosure, terms such as first, second, A, B, (a), and (b) may be used. These terms are only for distinguishing the components from other components, and the nature or order of the components is not limited by the terms. When a component is described as being "connected" or "coupled" to another component, the component may be directly connected to or coupled to the another component, but it should be understood that still another component may be "connected" or "coupled" thereto between each component.

Hereinafter, preferred embodiments of a dehumidifier of the present disclosure are described with reference to the attached drawings 1 to 15.

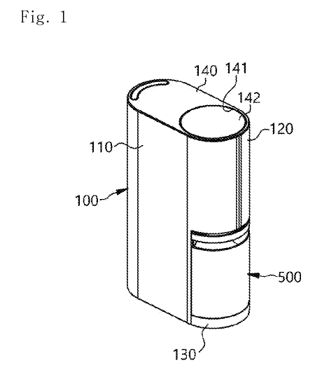

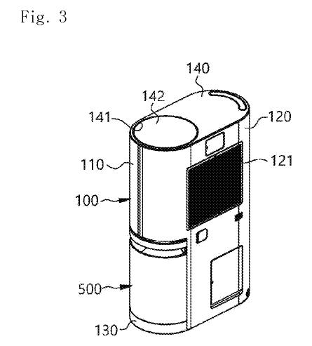

FIGS. 1-4 are perspective views and exploded perspective views of the dehumidifier shown in different directions according to the embodiment of the present disclosure.

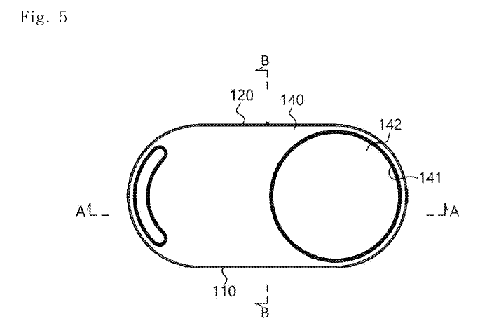

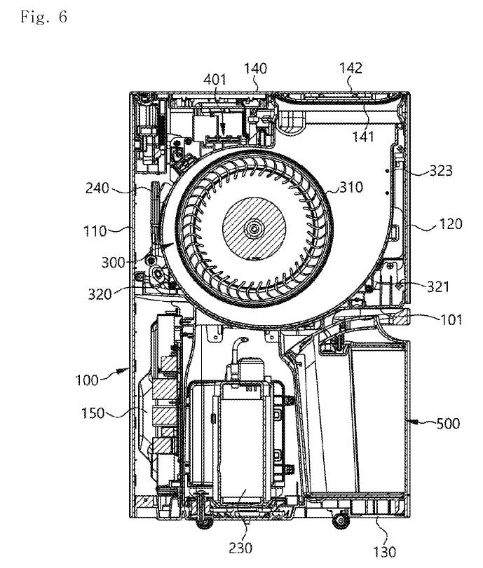

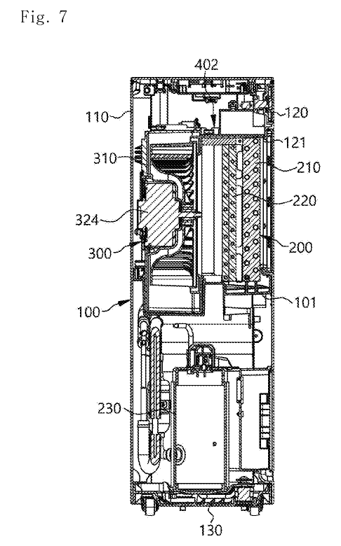

FIG. 5 is a plan view of the dehumidifier according to the embodiment of the present disclosure, and FIGS. 6 and 7 are cross-sectional views.

As shown in these drawings, the dehumidifier according to the embodiment of the present disclosure may include a casing 100, a dehumidifying part 200, and a fan assembly 300. A connector mounting part 401 and 402 for mounting a connector 40 of a wire connected to each electronic component may be included inside the casing 100.

A more detailed description of each component of the dehumidifier according to the embodiment of the present disclosure is as follows.

First, the casing 100 of the dehumidifier according to the embodiment of the present disclosure is described.

The casing 100 may be defined as the exterior of the dehumidifier. Various components or devices may be installed inside the casing 100.

Inside the casing 100, a plurality of spaces may be provided for installing the various components or devices. For example, the spaces may include a space in which a fan assembly 300 is installed, a space in which a compressor 230 is installed, a space in which a water tank 500 is installed, and a space in which a heat exchanger 210 and 220 is installed.

The spaces may be formed so that the spaces are separated from each other or some thereof communicate with each other. For example, a space in which the heat exchanger 210 and 220 is located and a space in which the water tank 500 is located may be partitioned from each other by a partition frame 101.

The casing 100 may be formed by coupling a plurality of parts to each other. For example, the casing 100 may be provided as being divided into a plurality of parts, such as a first peripheral casing 110, a second peripheral casing 120, a base frame 130, and an upper cover 140.

Although not shown, the first peripheral casing 110 and the second peripheral casing 120 may be formed integrally, one peripheral casing 110 or 120 and the base frame 130 may be formed integrally, or one peripheral casing 110 or 120 and the upper cover 140 may be formed integrally.

The first peripheral casing 110 may include one side wall, a portion of the front surface and a portion of the rear surface of the dehumidifier, and the second peripheral casing 120 may include the other side wall, the other portion of the front surface and the other portion of the rear surface of the dehumidifier. For convenience of explanation, the front surface may be defined as a surface on the side in which the water tank 500 is located, the first peripheral casing 110 may be defined as a wall surface provided on the left side when the water tank 500 is viewed from the front, and the second peripheral casing 120 may be defined as a wall surface provided on the right side when the water tank 500 is viewed from the front.

The second peripheral casing 120 may include an intake port 121 formed thereon. For example, the intake port 121 for drawing in indoor air may be formed on an upper portion of the side wall of the second peripheral casing 120.

The upper cover 140 may include a discharge port 141 formed thereon. For example, the discharge port 141 may be formed in the front portion of the upper cover 140.

The discharge port 141 may be selectively opened or closed by an opening/closing door 142. The opening/closing door 142 may be opened or closed manually or automatically.

The front lower portion of the casing 100 may be formed to be open. The water tank 500 may be detachably installed within the open portion. The water tank 500 may store moisture separated from air.

Next, the dehumidifying part 200 of the dehumidifier according to the embodiment of the present disclosure will be described.

The dehumidifying part 200 may be defined as a device, apparatus or structure for removing moisture from air.

For example, the dehumidifying part 200 may be configured to remove moisture contained in the air by heat exchange with the air by using a temperature difference. To this end, the dehumidifying part 200 may include the heat exchanger 210 and 220.

The heat exchanger 210 and 220 may include an evaporator 210 for removing moisture from the air by using a temperature difference with the air.

Air passing through the evaporator 210 may have a low temperature because it exchanges heat with the low-temperature refrigerant of the evaporator 210. When such low-temperature air is directly provided indoors, it may cause complaint of a user. By considering this, the heat exchanger 210 and 220 may include a condenser 220 for increasing the temperature of the air.

Meanwhile, the dehumidifying part 200 may be configured as a refrigeration cycle having the evaporator 210 and the condenser 220. To this end, the dehumidifying part 200 may further include the compressor 230.

The compressor 230 may be provided in the lower space within the casing 100. By placing the compressor 230, which is relatively heavier than other components, at the lower portion, the casing 100 may be prevented from tipping over.

The condenser 220 may be located on the air outlet side of the evaporator 210. In particular, the evaporator 210 and the condenser 220 may be positioned to overlap in an air flow direction and may be provided in a portion in which the intake port 121 of the second peripheral casing 120 is formed inside the casing 100. For example, the evaporator 210 and the condenser 220 may be provided in the right space of the upper portion within the casing 100. The evaporator 210 may be disposed to be closer to the intake port 121 than the condenser 220. By arranging the evaporator 210 and the condenser 220 in this way, air drawn in from the intake port 121 may be re-supplied indoors with its temperature increased after moisture of the air is removed.

That is, air drawn through the intake port 121 may undergo heat exchange while passing through the low-temperature evaporator 210, and moisture of the air may be removed through the heat exchange with low temperature. The air passing through the evaporator 210 may undergo heat exchange while passing through the high-temperature condenser 220, and may be heated to an appropriate temperature through the heat exchange with high temperature and discharged indoors. Accordingly, hot and dry air may be provided indoors.

Moisture separated from air while passing through the evaporator 210 may flow down along the surface of the evaporator 210, may be collected on the partition frame 101 located below the evaporator 210, and provided to the water tank 500 located below the partition frame 101.

Next, the fan assembly 300 of the dehumidifier according to the embodiment of the present disclosure will be described.

The fan assembly 300 may be defined as an assembly having a blower fan 310 to generate airflow.

The fan assembly 300 may be provided within the casing 100.

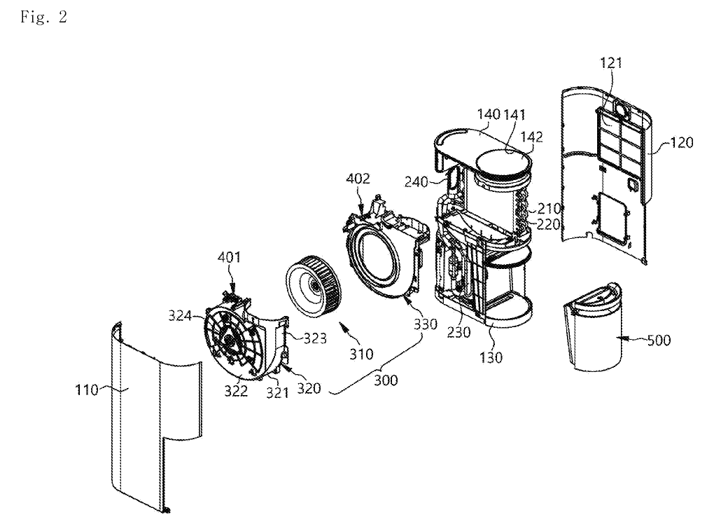

Specifically, as illustrated in FIGS. 2, 4, and 7, the fan assembly 300 may be located at the air outlet side of the heat exchanger 210 and 220 (particularly, the condenser). Accordingly, air that passes through the intake port 121 and sequentially passes through the evaporator 210 and the condenser 220 may be introduced into the fan assembly 300.

As illustrated in FIGS. 2, 4, 7, and 8, the fan assembly 300 may include a fan housing 320 and a shroud 330. The blower fan 310 may be installed within a space formed by combining the fan housing 320 and the shroud 330.

The fan housing 320 may be formed as a hollow body having a peripheral wall 321 for guiding airflow and a front wall 322, while having an open rear surface (a surface facing the intake port of the second peripheral casing).

The peripheral wall 321 may be formed to be round on the basis of the center of rotation of the blower fan 310, and a discharge duct 323 may be formed to guide the discharge flow of air while extending from one portion of the peripheral wall 321 to one wall surface of the casing 100. The end portion of the discharge duct 323 may be open and serve as an air outlet.

As shown in FIG. 6, the air outlet of the discharge duct 323 may be formed to align with the discharge port 141 of the upper cover 140 constituting the casing 100. That is, the discharge duct 323 may extend upward from the upper portion of the peripheral wall 321 of the fan housing 320 and be aligned with the discharge port 141. Accordingly, air flowing along the discharge duct 323 may sequentially pass through the air outlet and the discharge port 141 of the upper cover 140 and then may be discharged indoors.

The shroud 330 may be formed to cover the one open surface (the right surface in the drawing) of the fan housing 320. That is, the shroud 330 may formed to cover the one open surface of the fan housing 320 by being coupled to the one open surface of the fan housing 320.

The shroud 330 may have an air inlet for introducing air into the blower fan 310 within the fan housing 320. The air inlet of the shroud 330 may be positioned to face the intake port 121 of the second peripheral casing 120 constituting the casing 100. The heat exchanger 210 and 220 (the evaporator and the condenser) may be located between the air inlet of the shroud 330 and the intake port 121 of the second peripheral casing 120.

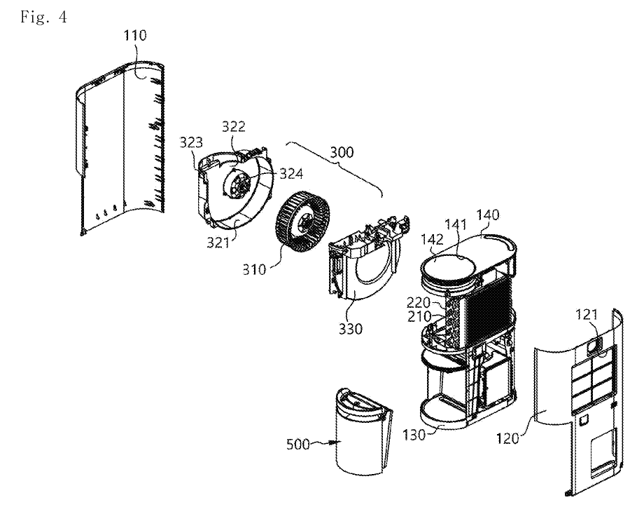

As shown in FIG. 4, a fan motor 324 may be installed on the outer surface of the fan housing 320, and the blower fan 310 may be positioned within the fan housing 320 and be axially coupled to the fan motor 324. The fan motor 324 may be installed to be recessed from the outer surface of the fan housing 320.

The blower fan 310 may be formed as a centrifugal fan (e.g., a sirocco fan) having one open surface (a surface facing the shroud) and multiple vanes formed along a circumference thereof. Accordingly, air may be drawn in through the air inlet of the shroud 330 by the rotation of the blower fan 310. The air thus drawn in may flow into the blower fan 310, be discharged in a radial direction, then flow along the peripheral wall 321 of the fan housing 320, pass through the discharge duct 323, and may be ultimately discharged through the discharge port 141.

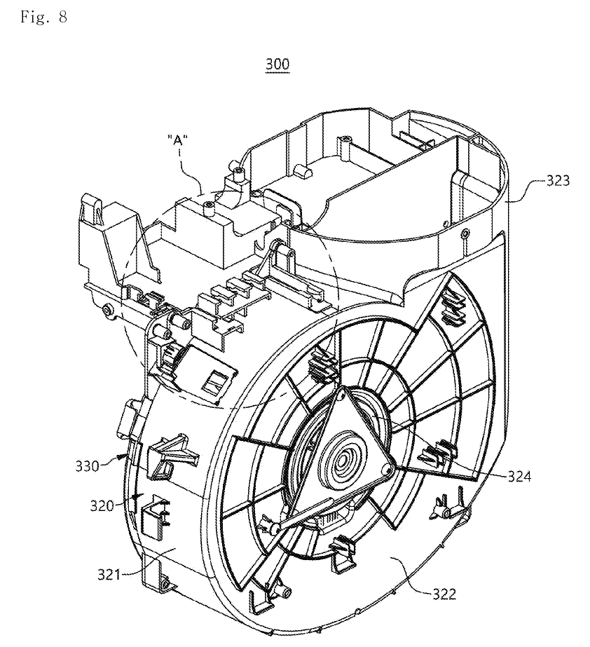

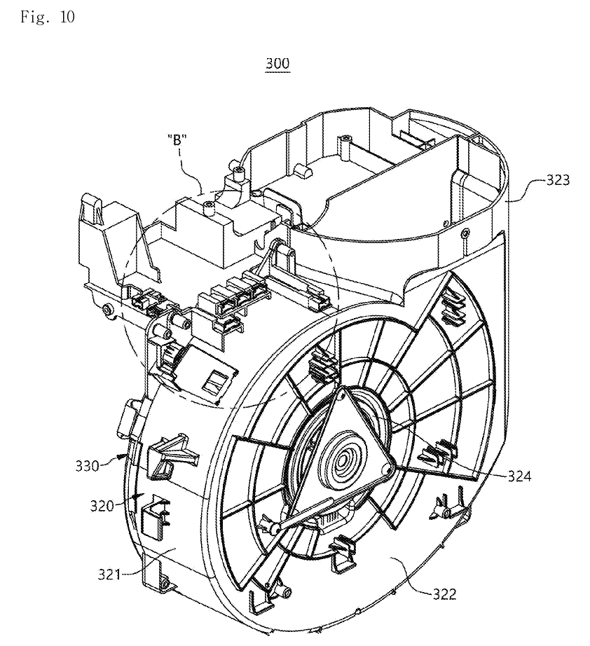

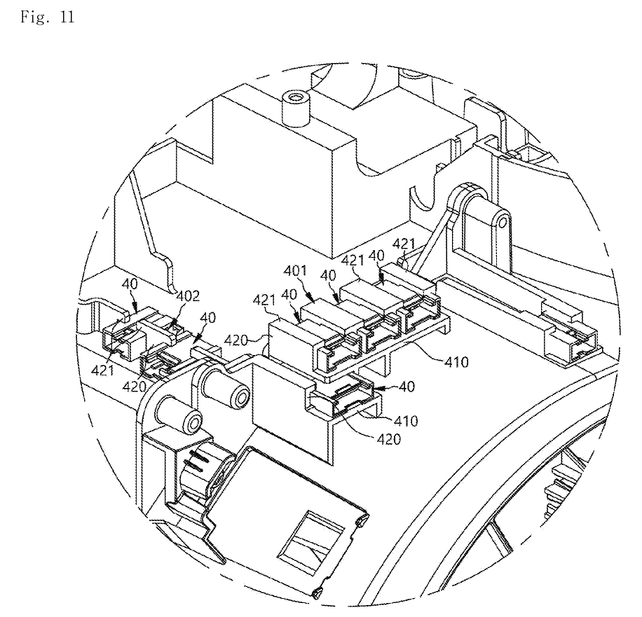

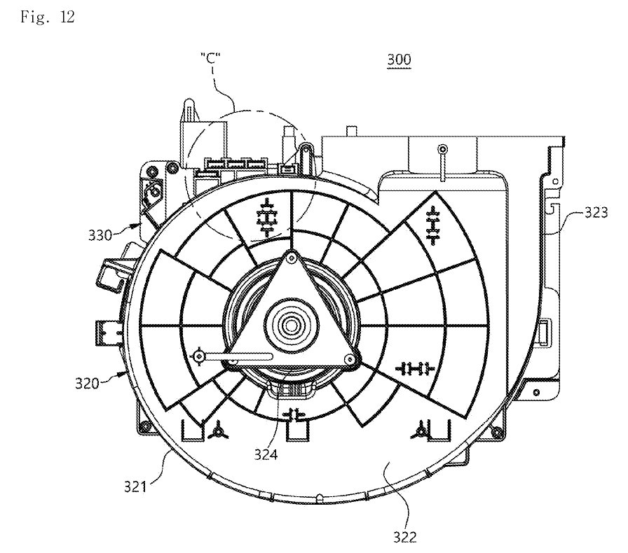

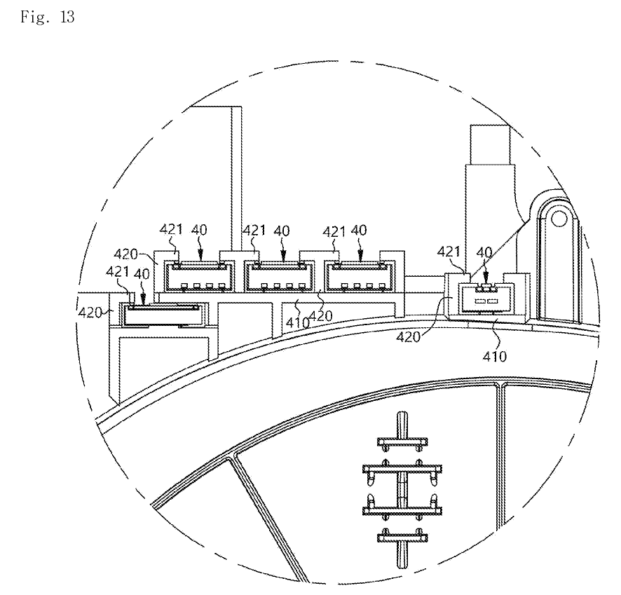

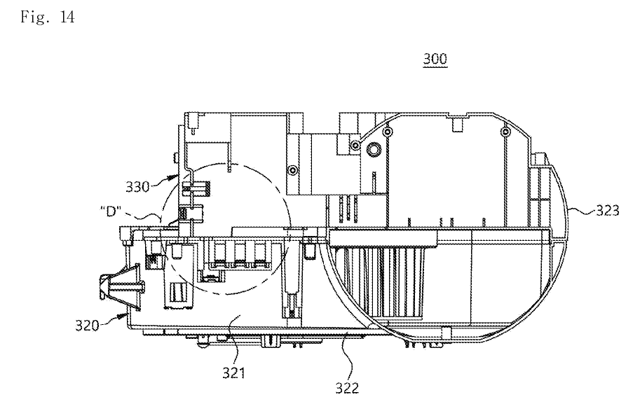

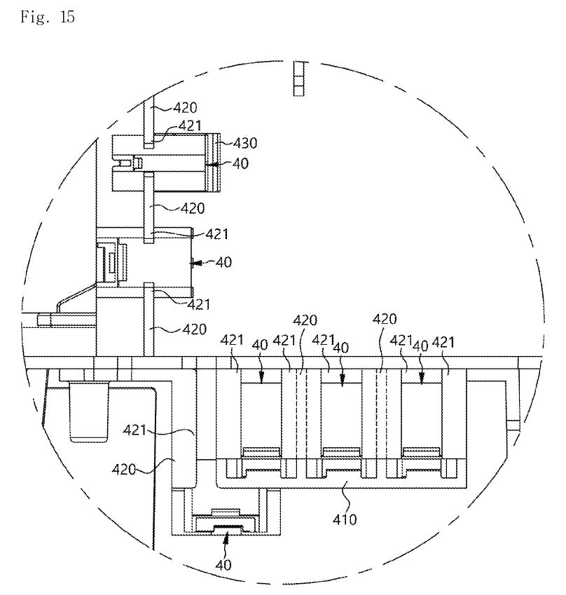

Next, the connector mounting part 401 and 402 of the dehumidifier according to the embodiment of the present disclosure will be described with reference to FIGS. 8 to 15.

The connector mounting parts 401 and 402 may be defined as a structure provided to mount a connector 40 coupled to the end of a wire (not shown), or a portion in which the structure is formed.

The wire may include at least one of wires connected to various devices (e.g., the water tank, the dehumidifying part, electrical components, etc.) provided within the casing 100. For example, the wire may include a wire connected to a sensor for detecting the water level of the water tank 500 or for detecting whether the water tank 500 is installed. The wire may include a wire connected to a sensor for detecting various conditions of the dehumidifying part 200.

The wire connected to each of the devices may include one or more wires for each device.

The connector mounting part 401 and 402 may be formed so that the connector 40 of each wire is mounted therein. That is, by providing the connector mounting part 401 and 402, entanglement between wires may be prevented, and interference caused by the wires may be prevented during assembly work.

In particular, the connector mounting part 401 and 402 enable connectors 40 of the same type of wires or wires connected to the same device to be mounted by type. Accordingly, a worker may accurately identify connected wires during maintenance of each device.

The connector mounting part 401 and 402 may be provided on the outer surface of any one of the various devices within the casing 100.

Preferably, the connector mounting part 401 and 402 may be provided on the fan housing 320 or the shroud 330 constituting the fan assembly 300. That is, the fan housing 320 and the shroud 330 may be the first components to be checked when the first peripheral casing 110 is separated. Additionally, even if the connector mounting part 401 and 402 is formed on each of the outer surfaces of the fan housing 320 and the shroud 330, it may not affect the performance of the dehumidifier. In addition, it may be most preferable that the fan housing 320 and the shroud 330 are easily formed by injection molding and are formed of a material that is not easily broken or damaged when the connectors 40 are coupled thereto. Although not shown, the connector mounting part 401 and 402 may be formed on one of the inner wall of the casing 100 and the outer surface of the heat exchanger 210 and 220 (the condenser or the evaporator).

The connector mounting part 401 and 402 may be formed on the upper surface of the fan housing 320 or the shroud 330. This structure may allow the connector mounting part 401 and 402 to be located on the upper side within the casing 100, so that a worker may easily find the connector mounting part 401 and 402 when removing the first peripheral casing 110.

In particular, the edge portion of the upper surface of the fan housing 320 or the shroud 330 may be provided as an empty space and may not be used for any other purpose. Considering this, the connector mounting part 401 and 402 may be formed on the edge portion of the upper surface of the fan housing 320 or the shroud 330ing, thereby making the installation of the connector 40 easier and space utilization possible.

The connector mounting part 401 and 402 may be formed to have a flat bottom portion 410. Accordingly, each connector 40 may be mounted horizontally even in a round portion, as in the edge of the fan housing 320.

The connector mounting part 401 and 402 may include the grip guide 420 for gripping the side surface of the connector 40. Preferably, two grip guides 420 may form one pair and may be formed to grip the opposite side surfaces of the connector 40. That is, by means of the two grip guides 420, the connector 40 may be mounted accurately without tilting left and right, and may be maintained in a stably mounted state without shaking left and right.

Preferably, the connector mounting part 401 and 402 may be formed to have both the bottom portion 410 and the two grip guides 420. In this case, the two grip guides 420 may be formed to protrude from the upper surface of the bottom portion 410. Accordingly, by means of the bottom portion 410 and the two grip guides 420, the connector 40 may be accurately mounted without tilting up and down or left and right, and may be maintained in a stably mounted state without shaking up and down or left and right.

Meanwhile, the grip guides 420 may include a plurality of pairs of grip guides so as to allow a plurality of connectors 40 to be collectively mounted to one connector mounting part 401 and 402.

When the grip guides 420 include a plurality of pairs of grip guides, each of the grip guides 420 may be arranged adjacently in a horizontal direction. With this structure, each connector 40 may be mounted side by side in a horizontal direction, and the mounting position of each connector 40 may be distinguished. For example, serial numbers may be assigned to portions in which connectors 40 are mounted along the horizontal direction, and each of the connectors 40 may be mounted according to the corresponding serial number. Accordingly, by checking the mounting position of the connector 40, a worker may know exactly which sensor (or device) a wire connected to the corresponding connector 40 is connected to.

When each of the grip guides 420 is arranged adjacently along the horizontal direction, spaces for mounting two connectors 40 may be provided for every three grip guides 420, thereby minimizing mounting spaces for a plurality of connectors 40.

The plurality of pairs of grip guides 420 may also be arranged in a plurality of layers. With this structure, a greater number of connectors 40 may be mounted, and a wire connected to each of the connectors 40 may be accurately identified simply by checking its mounting position.

The connector mounting part 401 and 402 may include a structure formed to prevent a mounted connector 40 (e.g., a female connector) from being pushed in a coupling direction when a counterpart connector (e.g., a male connector) is coupled to the mounted connector 40 mounted therein. That is, by providing the structure that prevents the mounted connector 40 from being pushed, the mounted connector 40 may be prevented from being unintentionally detached from the connector mounting part 401 and 402.

To this end, the connector mounting part 401 and 402 may include a limiting protrusion 431 and 432 that limits the insertion depth of the connector 40. The limiting protrusion 431 and 432 may be positioned to limit a connector 40 from being pushed in a direction in which a counterpart connector 40 is coupled to the connector 40, thereby allowing the connector 40 to be inserted into the connector mounting part 401 and 402 by only a predetermined depth without being excessively inserted therein.

The limiting protrusions 431 and 432 may include a first limiting protrusion 431 formed to protrude from the wall surface of the grip guide 420 in a direction in which the insertion of the connector 40 is blocked. The limiting protrusion 431 and 432 may further include a second limiting protrusion 432 formed to protrude from the upper surface of the bottom portion 410.

For the first limiting protrusion 431 and the second limiting protrusion 432, by considering the shape of the connector 40, the structure of the installation location of the connector mounting part 401 and 402, or the coupling direction of the connector 40, only one limiting protrusion may be formed, or both the limiting protrusions 431 and 432 may be formed.

The grip guide 420 may further include a structure that grips a portion of the upper surface of the connector 40. To this end, a bent end 421 may be formed on the upper end of the grip guide 420 to grip a portion of the upper surface of the connector 40. The bent end 421 may be formed to be bent from the upper end of the grip guide 420 toward the upper surface of the connector 40.

Meanwhile, the connector mounting part 401 and 402 may include two or more connector mounting parts. That is, the connector mounting part 401 and 402 may be provided not only in one portion but also in two or more portions.

For example, connectors 40 of wires connected to one device or apparatus may be collectively mounted in a connector mounting part (a first connector mounting part) 401 provided in a portion, and connectors 40 of wires connected to another device or apparatus may be collectively mounted in a connector mounting part (a second connector mounting part) 402 provided in another portion. That is, by arranging the wires of the same device to be collectively mounted on the same connector mounting part 401 and 402, a worker may quickly check whether a specific device is defective during maintenance work.

The connector mounting part 401 and 402 may include a first connector mounting part 401 formed on the outer surface of the fan housing 320. Connectors 40 of wires connected to sensors of devices constituting the dehumidifying part 200 may be mounted in the first connector mounting part 401. For example, a connector 40 of a wire connected to a sensor for detecting the temperature of the dehumidifying part 200, a sensor for detecting the contact of the heat exchanger 210, or 220, a sensor for detecting whether the fan is running may be mounted between the grip guides 420 of the first connector mounting part 401.

The first connector mounting part 401 may be formed on the edge of the upper end of the fan housing 320. Specifically, the first connector mounting part 401 may be formed on an edge of the upper surface of the fan housing 320 opposite to an edge from which the discharge duct 323 protrudes. Accordingly, the unused space on the edge of the upper end of the fan housing 320 may be utilized, thereby eliminating a need for additional space within the casing 100 to form the first connector mounting part 401.

The connector mounting part 401 and 402 may include a second connector mounting part 402 formed on the outer surface of the shroud 330. A connector 40 for a wire connected to a device, apparatus, or component other than the dehumidifying part 200 may be mounted in the second connector mounting part 402. For example, a connector 40 of a wire connected to a sensor for detecting the water level of the water tank 500 or a sensor for detecting whether the water tank 500 is mounted may be mounted between the grip guides 420 of the second connector mounting part 402.

The first connector mounting part 401 and the second connector mounting part 402 may be positioned to be adjacent to each other. This may allow work on connection portions between wires to be collectively performed in one location. For example, the first connector mounting part 401 may be formed on the edge of the upper surface of the fan housing 320, and the second connector mounting part 402 may be formed on a portion of the upper surface of the shroud 330 adjacent to the first connector mounting part 401.

Connectors 40 of wires connected to different devices may be respectively mounted in the first connector mounting part 401 and the second connector mounting part 402 provided in this manner. This is the same as the description of an example of each device mounted on each of the connector mounting part 401 and 402 described above. Accordingly, a worker may accurately identify a wire for each device.

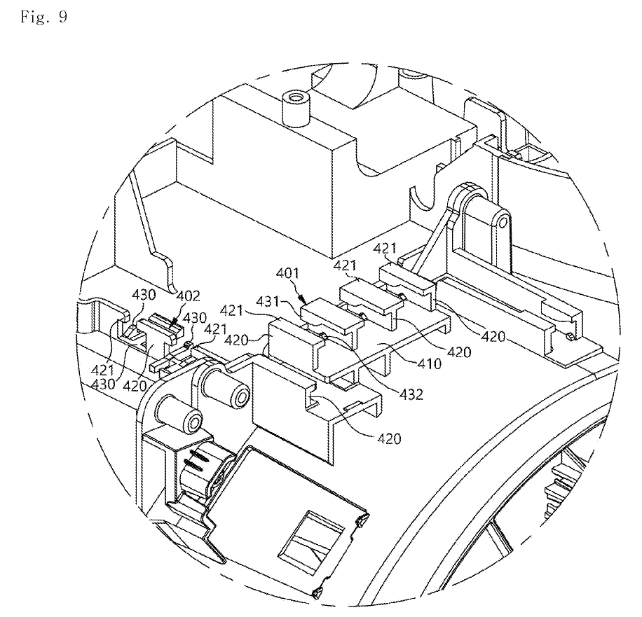

As shown in FIGS. 9, 11, 14, and 15, the two connector mounting parts 401 and 402 may be formed so that connectors 40 are respectively mounted in the two connector mounting parts 401 and 402 in different directions. This structure is intended to enable a worker to more easily identify each type of connector 40 connected to each of the connector mounting parts 401 and 402.

The first connector mounting part 401 may be formed so that the connector 40 is mounted in the width direction of the fan housing 320 (in the direction toward the shroud). Accordingly, the connector 40 may be mounted from the front of the fan housing 320, making connector mounting easy.

Hereinafter, the process of installing a connector 40 of each wire to the connector mounting part 401 and 402 in the dehumidifier of the present disclosure will be described.

First, each wire may be organized while each device that constitutes the dehumidifier is installed in each portion within the casing 100.

That is, after the assembly of each device is completed, the connector 40 provided on the end of each wire is mounted in each of the first connector mounting part 401 and the second connector mounting part 402 formed on the upper surfaces of the fan housing 320 and the shroud 330, respectively.

In this case, for example, connectors 40 of various wires related to the dehumidifying part 200 may be mounted in the first connector mounting part 401, and connectors 40 of various wires related to devices other than the dehumidifying part 200 may be mounted in the second connector mounting part 402.

In addition, different types of connectors 40 may be mounted separately on the upper and lower rows of the first connector mounting part 401.

Therefore, a worker may accurately recognize a wire, a sensor, or a device to which a connector 40 is connected simply by being familiar with the location of the connector mounting part 401 and 402 in which the connector 40 is mounted.

When the mounting of a connector 40 of each wire in each of the connector mounting parts 401 and 402 is completed, a counterpart connector (not shown) may be coupled to the connector 40. In this case, the counterpart connector may be a connector of a wire drawn from a controller 150.

The counterpart connector may be inserted into and coupled to each of the connectors 40. In the process of inserting the counterpart connector into each of the connectors 40, each of the connectors 40 may be pushed in a direction in which the counterpart connector is coupled thereto. However, since the limiting protrusion 431 and 432 is formed on each of the connector mounting parts 401 and 402 to prevent the connector 40 from being pushed, the coupling between the connector 40 and the counterpart connector may be performed accurately and completely.

Accordingly, in the dehumidifier of the present disclosure, the connector mounting part 401 and 402 may be provided, thereby allowing each wire to be organized without being tangled.

In the dehumidifier of the present disclosure, by providing the connector mounting part 401 and 402, a connector 40 provided on the end of each wire may be mounted in a predetermined position. Accordingly, a worker may easily locate each wire.

In the dehumidifier of the present disclosure, with the provision of the connector mounting part 401 and 402, connectors 40 may be categorized and positioned by type or device, thereby making maintenance by a worker easier and quicker.

In the dehumidifier of the present disclosure, the limiting protrusion 431 and 432 may be provided on the connector mounting part 401 and 402, thereby preventing inaccurate coupling between a connector 40 and a counterpart connector 40 due to the connector 40 pushed during coupling between the connectors 40.

In the dehumidifier of the present disclosure, the connector mounting part 401 and 402 may be provided at the edge portion of the upper surface of the fan housing 320 or the shroud 330 which is provided as an empty space, thereby making the installation of the connector easier and space utilization possible while remaining adjacent to the controller 150.

In the above, all the components according to the embodiments of the present disclosure are described as being coupled to each other as one or being operated in the coupled state, but the present disclosure is not necessarily limited to the embodiments. That is, if it is within the scope of the present disclosure, at least one of all of the components may be selectively combined and operated. In addition, the terms such as "include", "compose", or "have" as described above means that the corresponding components can be inherent unless specifically stated to the contrary. Accordingly, it should be interpreted that other components are not excluded, but may further be included. All terms, including technical or scientific terms, have the same meaning as generally understood by those skilled in the art to which the present disclosure belongs, unless otherwise defined. Commonly used terms, such as terms defined in a dictionary, should be interpreted as being consistent with the contextual meaning of the related art, and are not to be interpreted as ideal or excessively formal meanings unless explicitly defined in the present disclosure.

The above explanation is merely an exemplary description of the technical idea of the present disclosure, and those skilled in the art to which the present disclosure belongs may make various modifications and variations without departing from the essential characteristics of the present disclosure. Accordingly, the embodiments disclosed in the present disclosure are intended to explain rather than limit the technical idea of the present disclosure, and the scope of the technical idea of the present disclosure is not limited by these embodiments. The scope of protection of the present disclosure should be interpreted by the claims below, and all technical ideas within the equivalent scope should be interpreted as being included in the scope of the claims of the present disclosure.

What is claimed is:

1. A dehumidifier comprising:
a casing providing an installation space;
a dehumidifying part provided within the casing and configured to remove moisture from air; and
a fan assembly provided within the casing and having a blower fan for generating airflow,
wherein the dehumidifier further comprises a connector mounting part formed on the fan assembly so that a connector of a wire connected to each electronic component within the casing is mounted in the connector mounting part.

2. The dehumidifier of claim 1, wherein the fan assembly comprises:
a fan housing in which the blower fan is installed rotatably and having an air outlet; and
a shroud coupled to the fan housing and having an air inlet for introducing air into the blower fan within the fan housing,
wherein the connector mounting part is provided on at least one of the fan housing and the shroud.

3. The dehumidifier of claim 2, wherein the connector mounting part comprises a first connector mounting part formed on an outer surface of the fan housing.

4. The dehumidifier of claim 3, wherein the first connector mounting part is formed on one edge of the fan housing.

5. The dehumidifier of claim 3, wherein the connector mounting part comprises a second connector mounting part formed on an outer surface of the shroud.

6. The dehumidifier of claim 5, wherein the second connector mounting part is located at a position adjacent to the first connector mounting part on the outer surface of the shroud.

7. The dehumidifier of claim 5, wherein a connector of a wire connected to a sensor of the dehumidifying part is mounted in one of the first connector mounting part and the second connector mounting part.

8. The dehumidifier of claim 5, wherein a connector of a wire connected to a device, apparatus, or component other than the dehumidifying part is mounted in a remaining one of the first connector mounting part and the second connector mounting part.

9. The dehumidifier of claim 5, wherein the first connector mounting part and the second connector mounting part are formed such that connectors are respectively mounted in the first connector mounting part and the second connector mounting part in different directions.

10. The dehumidifier of claim 3, wherein the first connector mounting part is formed such that a connector is mounted therein toward a direction in which the fan housing faces the shroud.

11. The dehumidifier of claim 1, wherein the connector mounting part comprises:
a flat bottom portion; and
at least two grip guides protruding from an upper surface of the bottom portion and configured to grip side surfaces of the connector.

12. The dehumidifier of claim 11, wherein two grip guides of the grip guides form one pair and grip opposite side surfaces of the connector.

13. The dehumidifier of claim 12, wherein the grip guides comprise a plurality of pairs of grip guides arranged to be adjacent to each other in a horizontal direction.

14. The dehumidifier of claim 12, wherein the grip guides comprise a plurality of pairs of grip guides arranged in a plurality of vertical layers relative to each other.

15. The dehumidifier of claim 11, wherein the connector mounting part comprises a limiting protrusion provided between the two grip guides, with the limiting protrusion configured to limit an insertion depth of the connector inserted between the two grip guides.

16. The dehumidifier of claim 15, wherein the limiting protrusion is positioned to limit the connector of a wire from being pushed in a direction in which a counterpart connector of another wire is coupled to the connector.

17. The dehumidifier of claim 11, wherein on an upper end of each of the grip guides, a bent end is formed to grip a portion of an upper surface of the connector.

18. A dehumidifier comprising:
a casing providing an installation space;
a dehumidifying part provided within the casing and configured to remove moisture from air;
a fan assembly provided within the casing and having a blower fan for generating airflow; and
a plurality of connector mounting parts provided on one outer surface of the fan assembly so that connectors of wires connected to respective electronic components within the casing are mounted in the connector mounting parts.

19. The dehumidifier of claim 18, wherein a connector of a wire connected to a sensor provided for sensing the dehumidifying part is mounted in one connector mounting part of the plurality of connector mounting parts.

20. The dehumidifier of claim 18, wherein a connector of a wire connected to a device, apparatus, or component other than the dehumidifying part is mounted in one connector mounting part of the plurality of connector mounting parts.
